(19) United States
(12) Patent Application Publication
(10) Pub. No.: US 2006/0002306 A1
(43) Pub. Date: Jan. 5, 2006

(54) Failure detection of path information corresponding to a transmission path

(76) Inventors: Ronald Brown, Helsinki (FI); Andreas Heiner, Espoo (FI); Ove Strandberg, Lappbole (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/170,101

(22) Filed: Jun. 30, 2005

Related U.S. Application Data
(60) Provisional application No. 60/583,845, filed on Jun. 30, 2004.

(51) Int. Cl. H04L 12/26

(52) U.S. Cl. 370/241; 370/351

(57) ABSTRACT

A method, system, peers and computer programs determine validity of path information corresponding to a transmission path between a monitoring peer and a monitored peer in a data communication network. The monitoring peer monitors unsolicited data received from the monitored peer via the reverse transmission path identified by the path information and further monitors any data sent to the monitored peer using the path information. Validity tests are performed by the monitoring peer for the path information to restore complete confidence in its validity in a way where the rate of testing is proportional to the rate of receiving unsolicited data from the monitored peer and to the rate of sending data to the monitored peer. The monitoring peer invalidates the path information if the validity test fails.

### BACKGROUND OF THE INVENTION

1. Field of the Invention

The invention relates data communication systems. In particular, the invention relates to method, system, peers and computer programs, which are novel and improved, for determining validity of path information corresponding to a transmission path between a monitoring peer and a monitored peer in a data communication network.

2. Description of the Related Art

The Internet is based on packet forwarding nodes where data packets are sent from one node to another until the destination is reached. Thus all nodes forward data except the last. Forwarding at intermediated nodes, including the source node, is based on routing table information to resolve what is the next node and transmission path for reaching it, given the packet's destination address. When a node receives a packet with a destination address which is not its own, an attempt is made to forward the packet to the next node, resolved by searching its routing table.

When the next node is connected to the forwarding node via a point-to-point path, the outgoing interface is sufficient to identify the next node. The use of shared media in the physical path between nodes introduces the need for Media Access Control (MAC) addresses for the interfaces in order to select the target node to receive the forwarded packet. This means, of course, the need for the next node to be identified by both the outgoing interface and its MAC address on the shared media.

In either case, the transmission path between a monitoring (forwarding) node and a monitored (next) node is determined by its corresponding path information (route table entry). Hereafter, the terms “transmission path” and equivalently “path” and “route path” correspond to the path information maintained in and used by the forwarding node, and include handling by the next node. These terms refer to the uni-directional end-to-end Internet Protocol (IP) path from the forwarding node to the next node, and the path is assumed to exist and be fully useable when the path information (route) that defines it is selected for use in forwarding. Its local end point is identified by the interface identifier, and remote end point by the forwarding address to the next node. The forwarding address is an abstraction, which identifies the next node's MAC address, if needed, for the given interface, usually in terms of an IP address associated with the next node. Whether or not bi-directionality can further be implied is a matter of how the transmission path is established and maintained. The point is that the path information becomes invalid when the transmission path and/or next node fails, that is, when the forwarded packet is not received.

While some routing table information is manually maintained, the design goals of dynamic flexibility for the Internet have lead to the vast study of routing protocols used by the peer nodes to automatically maintain their routing tables. This information is exchanged over the same interfaces used to send user data in order to learn network topology and adapt to changes in it, thus keeping the routing tables up to date without human intervention. There is a distinct difference in the amount of data and the frequency of exchanging it for the two processes of establishing and invalidating a transmission path, as will be detailed in the discussion of the problem.

Practical routing protocols actually rely on bi-directionality to establish and maintain validity of a transmission path. For example, link-state protocols use handshake procedures to establish and maintain bi-directional links, which then are used to define routes; distant-vector protocols infer the return path in defining route paths based on advertisements received on a given interface. In the latter case the inference is a serious mistake if the path is not bi-directional, or if the transmission path can fail undetected by other mechanisms while the incoming path defining it remains operational. In most practical systems the risk of such a failure is considered low enough to be worth taking. In both cases, the methods aim to detect an invalid route through use of periodically exchanged information to refresh an expirable (aged) route defining mechanism.

A fundamental problem in maintaining IP routing tables stems from the very source of the routing flexibility. The problem begins with the fact that the data paths are used in the route table building process so that the benefit in flexibility gained by exchanging routing information extracts a cost in bandwidth then unavailable for user data.

Exchange of routing information is not a one-time process, but needs to be updated as network policy or topology changes. The latter includes faults, which are unscheduled by nature and require fast corrective procedures, beginning with fast detection of the fault. Other updates to routing tables can readily be synchronized to administrative procedures, and if fault detection were external to the route table building process, the exchange of updated routing information could also wait for the error to occur.

Some external monitoring can detect hardware transmission breakdown and signal the relevant software layers, but cannot always guarantee detection of soft failure over the whole transmission path. End-toend IP data paths can consist of many lower layer relay systems, e.g. bridges, tunnels. With many, and especially shared media technologies, error detection is possible only at one end of an IP routing path. So, updates of routing table information cannot be synchronized reliably with the failures of the data paths between nodes. The only means to ensure failure detection of an end-to-end IP data path between nodes is to continually test it for successful operation of the transmission path.

Each node is primarily concerned with maintaining correct route paths. The information required to monitor them for correctness requires every practical routing protocol to periodically receive information to confirm that its routing tables are correct. In general, the more often the information is received, the more responsive the protocol is in adapting to changes, but the more useful bandwidth is degraded.

In earlier networks lower requirements for failure detection were tolerated. As the requirements increased for faster failure detection, the cost in bandwidth of refreshing routing information quickly lead to the obvious solution of detaching the route refresh mechanism from the route information itself. There was a drive to invent low bandwidth handshake protocols to ensure the route path was functional. The results were the well-known “hello” protocols. These reduced the failure detection time cost in bandwidth, but the cost is still driven too high to meet detection after the loss of only a small number of packets.

In the focus to separate the route refresh mechanism from the route information itself, all earlier solutions have created new protocols, or cleverly used existing ones, which are focused on IP end points and so use unicast addresses. These solutions becomes impractical as the number of route-paths or “links” to be protected over a shared media increases because they are protected independently and the refresh data of one node contends for possible user bandwidth of other nodes sharing the media.

A general problem remains in the existing solutions: how to quickly determine the event of failure, invalidating path information stored in a nodes routing table, without degrading performance of the network in the process, and of course with low cost of implementation.

Furthermore, in prior art solutions the system is tested by prompting for the extra data by sending extra data regularly. Using the mechanisms of an extra user, even a lightweight protocol cannot afford fast failure detection for the general case.

Moreover, prior art solutions have left the problem of determining a rate for testing with extra data as an administrative issue to be solved by taking into consideration of all the parameters to arrive at a constant value which must serve for the varying traffic patterns on the interface in question.

### SUMMARY OF THE INVENTION

The invention discloses a solution to the general problem how to continually monitor a transmission path for failure without significantly degrading useful bandwidth.

According to one aspect of the invention there is provided a method of determining validity of path information corresponding to a transmission path between a monitoring peer and a monitored peer in a data communication network. The method comprises monitoring unsolicited data received from a monitored peer via the reverse transmission path associated with a forward transmission path identified by path information, monitoring any data sent to the monitored peer using the path information, performing validity tests by a monitoring peer for the path information to restore complete confidence in its validity in a way where the rate of testing is proportional to the rate of receiving unsolicited data from the monitored peer and to the rate of sending data to the monitored peer, and invalidating the path information if a validity test fails.

In one embodiment of the invention, the method further comprises determining a confidence factor representing the validity of the path information corresponding to the transmission path between the monitoring peer and the monitored peer, increasing the confidence factor when receiving unsolicited data from the monitored peer, decreasing the confidence factor when using the path information to send data from the monitoring peer to the monitored peer, and initiating a validity test for the path information to restore complete confidence in its validity when the value of the confidence factor reaches a predetermined low.

In one embodiment of the invention, the method further comprises determining a minimum rate of initiating the validity test, and initiating the validity test of the path information at least at intervals determined by the minimum rate.

In one embodiment of the invention, the method further comprises sending a request from the monitoring peer to the monitored peer, and invalidating the path information if the monitoring peer does not receive a predetermined confirmation in response to the request from the monitored peer.

In one embodiment of the invention, the method further comprises invalidating the path information if the monitoring peer does not receive the predetermined confirmation in response to the request from the monitored peer within a predetermined time interval.

In one embodiment of the invention, at least one of the predetermined request and the predetermined confirmation comprises at least one internet protocol packet dedicated for testing path information validity.

In one embodiment of the invention, the predetermined request and the predetermined confirmation are identified by at least one field of at least one internet protocol packet.

In one embodiment of the invention, the method further comprises sending a predetermined sequence of internet protocol packets dedicated for testing path information validity to a monitored peer from a monitoring peer, and invalidating the path information if the monitoring peer does not receive a predetermined response sequence of internet protocol packets dedicated for testing path information validity in response to the predetermined sequence of dedicatedinternet protocol packets from the monitored peer.

In one embodiment of the invention, the method further comprises invalidating the path information if the monitoring peer does not receive a predetermined response sequence of internet protocol packets dedicated for testing path information validity in response to the predetermined sequence of dedicatedinternet protocol packets from the monitored peer within a predetermined time interval.

In one embodiment of the invention, the method further comprises including at least one unicast internet protocol packet in the predetermined sequence of internet protocol packets dedicated for testing path information validity from the monitoring peer to the monitored peer; and including at least one unicast internet protocol packet and at least one broadcast internet protocol packet in the predetermined response sequence of internet protocol packets dedicated for testing path information validity from the monitored peer.

In one embodiment of the invention, the method further comprises agreeing to an identifier for the monitoring peer and the monitored peer by exchanging a predetermined sequence of internet protocol packets dedicated for testing path information validity between the monitoring peer and the monitored peer, wherein at least one field of an internet protocol packet is used for identifying the identifier, and after agreeing the identifier, identifying the predetermined request and the predetermined confirmation by using at least one internet protocol packet dedicated for testing path information validity, wherein the at least one field of at least one dedicated internet protocol packet comprises the identifier.

According to another aspect of the invention there is provided a computer program embodied on a computer readable medium for determining validity of path information corresponding to a transmission path between a monitoring peer and a monitored peer in a data communication network, the computer program controls the data-processing device to perform the following steps: monitoring unsolicited data received from a monitored peer via the reverse transmission path associated with a forward transmission path identified by path information, monitoring any data sent to the monitored peer using the path information, performing validity tests by the monitoring peer for the path information to restore complete confidence in its validity in a way where the rate of testing is proportional to the rate of receiving unsolicited data from the monitored peer and to the rate of sending data to the monitored peer, and invalidating the path information if a validity test fails.

In one embodiment of the invention, the computer program further controls the data-processing device to perform the following steps: determining a confidence factor representing the validity of the path information corresponding to a transmission path between the monitoring peer and the monitored peer, increasing the confidence factor when receiving unsolicited data from the monitored peer, decreasing the confidence factor when using the path information to send data from the monitoring peer to the monitored peer, and initiating a validity test for the path information to restore complete confidence in its validity when the value of the confidence factor reaches a predetermined low.

In one embodiment of the invention, the computer program controls the data-processing device to perform the following steps: determining a minimum rate of initiating the validity test, and initiating the validity test of the path information at least at intervals determined by the minimum rate.

In one embodiment of the invention, the computer program controls the data-processing device to perform the following steps: sending a request from the monitoring peer to the monitored peer, and invalidating the path information if the monitoring peer does not receive a predetermined confirmation in response to the request from the monitored peer.

In one embodiment of the invention, the computer program controls the data-processing device to perform the following step: invalidating the path information if the monitoring peer does not receive the predetermined confirmation in response to the request from the monitored peer within a predetermined time interval.

In one embodiment of the invention, at least one of the predetermined request and the predetermined confirmation comprises at least one internet protocol packet dedicated for testing path information validity.

In one embodiment of the invention, the predetermined request and the predetermined confirmation are identified by at least one field of at least one internet protocol packet.

In one embodiment of the invention, the computer program controls a data-processing device to perform the following steps: sending a predetermined sequence of internet protocol packets dedicated for testing path information validity to the monitored peer, and invalidating the path information if a predetermined response sequence of internet protocol packets dedicated for testing path information validity in response to the predetermined sequence of internet protocol packets is not received from the monitored peer.

In one embodiment of the invention, the computer program controls the data-processing device to perform the following steps: invalidating the path information if the predetermined response sequence of internet protocol packets dedicated for testing path information validity in response to the predetermined sequence of dedicated internet protocol packets is not received from the monitored peer within a predetermined time interval.

In one embodiment of the invention, the computer program controls the data-processing device to perform the following steps: including at least one unicast internet protocol packet in the predetermined sequence of internet protocol packets dedicated for testing path information validity from the monitoring peer to the monitored peer; and including at least one unicast internet protocol packet and at least one broadcast internet protocol packet in the predetermined response sequence of internet protocol packets dedicated for testing path information validity from the monitored peer.

In one embodiment of the invention, the computer program controls the data-processing device to perform the following steps: agreeing to an identifier for the monitoring peer and the monitored peer by exchanging a predetermined sequence of internet protocol packets dedicated for testing path information validity between the monitoring peer and the monitored peer, wherein at least one field of an internet protocol packet is used for identifying the identifier, and after agreeing the identifier, identifying the predetermined request and the predetermined confirmation by using at least one internet protocol packet dedicated for testing path information validity, wherein the at least one field of at least one dedicated internet protocol packet comprises the identifier.

In one embodiment of the invention, the computer program is stored on said computer readable medium.

According to another aspect of the invention there is provided a computer program embodied on a computer readable medium for sending data to a monitoring peer in a data communication network, the computer program controls the data-processing device to perform the following steps: sending unsolicited data via a reverse transmission path to a monitoring peer, receiving a validity test from the monitoring peer, and sending a predetermined confirmation to the monitoring peer in response to the validity test.

In one embodiment of the invention, the predetermined confirmation is identified by at least one field of at least one internet protocol packet.

In one embodiment of the invention, wherein the computer program controls the data-processing device to perform the following step: sending at least one internet protocol packet dedicated for testing path information validity as a confirmation to the monitoring peer in response to the validity test.

In one embodiment of the invention, wherein the computer program controls the data-processing device to perform the following steps: receiving from the monitoring peer a predetermined sequence of internet protocol packets dedicated for testing path information validity, and sending, in response to the predetermined sequence of dedicated internet protocol packets, a predetermined response sequence of internet protocol packets dedicated for testing path information validity to the monitoring peer.

In one embodiment of the invention, the predetermined sequence of internet protocol packets dedicated for testing path information validity from the monitoring peer comprises at least one unicast internet protocol packet, and the predetermined response sequence of internet protocol packets dedicated for testing path information validity to the monitoring peer comprises at least one unicast internet protocol packet and at least one broadcast internet protocol packet.

In one embodiment of the invention, wherein the computer program controls the data-processing device to perform the following steps: agreeing to an identifier for the monitoring peer and the monitored peer by exchanging a predetermined sequence of internet protocol packets dedicated for testing path information validity between the monitoring peer and the monitored peer, wherein at least one field of an internet protocol packet is used for identifying the identifier, and after agreeing the identifier, identifying the predetermined request and the predetermined confirmation by using at least one internet protocol packet dedicated for testing path information validity, wherein at least one field of at least one dedicated internet protocol packet comprises the identifier.

In one embodiment of the invention, the computer program is stored on said computer readable medium.

According to another aspect of the invention there is provided a monitoring peer for determining validity of path information corresponding to a transmission path between the monitoring peer and a monitored peer in a data communication network, the monitoring peer comprising a first failure monitor configured to monitor unsolicited data received from a monitored peer via a reverse transmission path associated with a forward transmission path identified by path information, to monitor any data sent to the monitored peer using the path information, to perform validity tests for the path information to restore complete confidence in its validity in a way where the rate of testing is proportional to the rate of receiving unsolicited data from the monitored peer and to the rate of sending data to the monitored peer and to invalidate the path information if a validity test fails.

In one embodiment of the invention, the first failure monitor is further configured to determine a confidence factor representing the validity of the path information corresponding to the transmission path between the monitoring peer and the monitored peer, to increase the confidence factor when receiving unsolicited data from the monitored peer, to decrease the confidence factor when using the path information to send data from the monitoring peer to the monitored peer and initiate the validity test for the path information to restore complete confidence in the validity when a value of the confidence factor reaches a predetermined low.

In one embodiment of the invention, the first failure monitor is further configured to determine a minimum rate of initiating the validity test and to initiate the validity test of the path information at least at intervals determined by the minimum rate.

In one embodiment of the invention, the first failure monitor is further configured to send a request to the monitored peer and to invalidate the path information if a predetermined confirmation is not received in response to the request from the monitored peer.

In one embodiment of the invention, the first failure monitor is configured to invalidate the path information if the predetermined confirmation in response to the request from the monitored peer is not received within a predetermined time interval.

In one embodiment of the invention, at least one of the predetermined request and the predetermined confirmation comprises at least one internet protocol packet dedicated for testing path information validity.

In one embodiment of the invention, the predetermined request and the predetermined confirmation are identified by at least one field of at least one internet protocol packet.

In one embodiment of the invention, the first failure monitor is further is configured to send a predetermined sequence of internet protocol packets dedicated for testing path information validity to the monitored peer and to invalidate the path information if a predetermined response sequence of internet protocol packets dedicated for testing path information validity in response to the predetermined sequence of dedicated internet protocol packets is not received from the monitored peer.

In one embodiment of the invention, the first failure monitor is configured to invalidate the path information if the predetermined response sequence of internet protocol packets dedicated for testing path information validity in response to the predetermined sequence of dedicated internet protocol packets is not received from the monitored peer within a predetermined time interval.

In one embodiment of the invention, the predetermined sequence of internet protocol packets dedicated for testing path information validity sent to the monitored peer comprises at least one unicast internet protocol packet and the predetermined response sequence of internet protocol packets dedicated for testing path information validity received from the monitored peer comprises at least one unicast internet protocol packet and at least one broadcast internet protocol packet.

In one embodiment of the invention, the first failure monitor is further configured to agree to an identifier for the monitoring peer and the monitored peer by exchanging a predetermined sequence of internet protocol packets dedicated for testing path information validity between the monitoring peer and the monitored peer, wherein at least one field of an internet protocol packet is used for identifying the identifier, and after agreeing to the identifier, to identify the predetermined request and the predetermined confirmation by using at least one internet protocol packet dedicated for testing path information validity, wherein at least one field of the at least one dedicated internet protocol packet comprises the identifier.

According to another aspect of the invention there is provided a monitored peer for sending data to a monitoring peer in a data communication network, the monitored peer comprising a failure monitor configured to send unsolicited data via a reverse transmission path to a monitoring peer, to receive a validity test from the monitoring peer and to send a predetermined confirmation to the monitoring peer in response to the validity test.

In one embodiment of the invention, the predetermined confirmation is identified by at least one field of at least one internet protocol packet.

In one embodiment of the invention, the failure monitor is configured to send at least one internet protocol packet dedicated for testing path information validity as the predetermined confirmation to the monitoring peer in response to the validity test.

In one embodiment of the invention, the failure monitor is configured to receive a predetermined sequence of internet protocol packets dedicated for testing path information validity from the monitoring peer and to send, in response to the predetermined sequence of dedicated internet protocol packets, a predetermined response sequence of internet protocol packets dedicated for testing path information validity to the monitoring peer.

In one embodiment of the invention, the predetermined sequence of internet protocol packets dedicated for testing path information validity from the monitoring peer comprises at least one unicast internet protocol packet and the predetermined response sequence of internet protocol packets dedicated for testing path information validity to the monitoring peer comprises at least one unicast internet protocol packet and at least one broadcast internet protocol packet.

In one embodiment of the invention, the second failure monitor is configured to agree to an identifier for the monitoring peer and the monitored peer by exchanging a predetermined sequence of internet protocol packets dedicated for testing path information validity between the monitoring peer and the monitored peer, wherein at least one field of an internet protocol packet is used for identifying the identifier, and after agreeing to the identifier, to identify the predetermined request and the predetermined confirmation by using at least one internet protocol packet dedicated for testing path information validity, wherein the at least one field of at least one dedicated internet protocol packet comprises the identifier.

According to another aspect of the invention there is provided a system of determining validity of path information corresponding to a transmission path between a monitoring peer and a monitored peer in a data communication network. The system comprises a monitoring peer comprising a first failure monitor, said first failure monitor being configured to monitor unsolicited data received from a monitored peer via a reverse transmission path associated with a forward transmission path identified by the path information, to monitor any data sent to the monitored peer using the path information, to perform validity tests for the path information to restore complete confidence in its validity in a way where the rate of testing is proportional to the rate of receiving unsolicited data from the monitored peer and to the rate of sending data to the monitored peer and to invalidate the path information if the validity test fails; and a monitored peer comprising a second failure monitor, said second failure monitor being configured to send unsolicited data via the reverse transmission path to the monitoring peer, to receive the validity test from the monitoring peer and to send a predetermined confirmation to the monitoring peer in response to the validity test.

In one embodiment of the invention, the first failure monitor is further configured to determine a confidence factor representing the validity of the path information corresponding to the transmission path between the monitoring peer and the monitored peer, to increase the confidence factor when receiving unsolicited data from the monitored peer, to decrease the confidence factor when using the path information to send data from the monitoring peer to the monitored peer and to initiate the validity test for the path information to restore complete confidence in the validity when a value of the confidence factor reaches a predetermined low.

In one embodiment of the invention, the first failure monitor is further configured to determine a minimum rate of initiating the validity test and to initiate the validity test of the path information at least at intervals determined by the minimum rate.

In one embodiment of the invention, the first failure monitor is further configured to send a request to the monitored peer and to invalidate the path information if the predetermined confirmation is not received in response to the request from the monitored peer.

In one embodiment of the invention, the first failure monitor is configured to invalidate the path information if the predetermined confirmation in response to the request from the monitored peer is not received within a predetermined time interval.

In one embodiment of the invention, at least one of the predetermined request and the predetermined confirmation comprises at least one internet protocol packet dedicated for testing path information validity.

In one embodiment of the invention, the predetermined request and the predetermined confirmation are identified by at least one field of at least one internet protocol packet.

In one embodiment of the invention, the first failure monitor is further configured to send a predetermined sequence of internet protocol packets dedicated for testing path information validity to the monitored peer, the second failure monitor is configured to receive the predetermined sequence of dedicated internet protocol packets, the second failure monitor is configured to send, in response to the predetermined sequence of dedicated internet protocol packets, a predetermined response sequence of internet protocol packets dedicated for testing path information validity to the monitoring peer, and the first failure monitor is configured to invalidate the path information if a predetermined response sequence of dedicated internet protocol packets in response to the sent predetermined sequence of dedicated internet protocol packets is not received from the monitored peer.

In one embodiment of the invention, the first failure monitor is configured to invalidate the path information if the predetermined response sequence of internet protocol packets dedicated for testing path information validity in response to the predetermined sequence of internet protocol packets dedicated for testing path information validity is not received from the monitored peer within a predetermined time interval.

In one embodiment of the invention, the predetermined sequence of internet protocol packets dedicated for testing path information validity sent to the monitored peer comprises at least one unicast internet protocol packet and the predetermined response sequence of internet protocol packets dedicated for testing path information validity received from the monitored peer comprises at least one unicast internet protocol packet and at least one broadcast internet protocol packet.

In one embodiment of the invention, the first failure monitor and the second failure monitor are further configured to agree to an identifier for the monitoring peer and the monitored peer by exchanging a predetermined sequence of internet protocol packets dedicated for testing path information validity between the monitoring peer and the monitored peer, wherein at least one field of an internet protocol packet is used for identifying the identifier, and after agreeing to the identifier, to identify the predetermined request and the predetermined confirmation by using at least one internet protocol packet dedicated for testing path information validity, wherein the at least one field of at least one dedicated internet protocol packet comprises the identifier.

According to another aspect of the invention there is provided a system of determining validity of path information corresponding to a transmission path in a data communication network, the system comprising first monitoring means for monitoring unsolicited data received from a monitored peer via a reverse transmission path associated with a forward transmission path identified by path information, second monitoring means for monitoring any data sent to the monitored peer using the path information, testing means for performing validity tests by a monitoring peer for the path information to restore complete confidence in its validity in a way where the rate of testing is proportional to the rate of receiving unsolicited data from the monitored peer and to the rate of sending the data to the monitored peer, and invalidating means for invalidating the path information if a validity test fails.

According to another aspect of the invention there is provided a system of sending data to a monitoring peer in a data communication network, the system comprising first sending means for sending unsolicited data via a reverse transmission path to a monitoring peer, receiving means for receiving a validity test from the monitoring peer, and second sending means for sending a predetermined confirmation to the monitoring peer in response to the validity test.

According to another aspect of the invention there is provided a method of sending data to a monitoring peer in a data communication network, the method comprising sending unsolicited data via a reverse transmission path to a monitoring peer, receiving a validity test from the monitoring peer, and sending a predetermined confirmation to the monitoring peer in response to the validity test.

According to another aspect of the invention the internet protocol packets dedicated for testing path information validity are effectively empty of data.

The invention has several advantages over the prior-art solutions. The invention solution recognizes that many nodes on a shared media have a common next node, i.e. remote end point, in the route paths of their routing tables, and may use a multicast protocol to create collaborative effort between the nodes in both directions of any required handshakes, thus eliminating all redundancy and allowing the refresh data interference with user bandwidth to be minimal.

The invention furthermore exploits all data sent on the route path to reduce frequency of refresh data and to use effectively empty data packets to reduce the amount of refresh data.

Furthermore, the invention discloses a very light protocol that can be used for testing the validity of path information.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow diagram illustrating an embodiment of a method according to the invention,

FIGS. 2a and 2b are signaling diagrams illustrating embodiments of packet sequences between a monitoring peer and a monitored peer according to the invention,

FIG. 3 is a signaling diagram illustrating an embodiment of packet sequences of concurrent testing between a monitoring peer and a monitored peer according to the invention,

FIG. 4 is a signaling diagram illustrating an embodiment, in which two monitoring peers are testing a monitored peer according to the invention,

FIGS. 5a and 5b are signaling diagrams illustrating embodiments of packet sequences between a monitoring peer and a monitored peer according to the invention,

FIG. 5c is a signaling diagram illustrating an embodiment of packet sequences of concurrent testing between a monitoring peer and a monitored peer according to the invention,

FIG. 6 is a flow diagram illustrating packet input processing according to the invention,

FIG. 7 is a flow diagram illustrating packet input processing in more detail according to the invention,

FIG. 8 is a flow diagram illustrating packet output processing according to the invention, and

FIG. 9 is a block diagram illustrating an embodiment of a system according to the invention.

### DETAILED DESCRIPTION OF THE PREFERRED EMBODIMENTS

Reference will now be made in detail to the embodiments of the present invention, examples of which are illustrated in the accompanying drawings. Data packets dedicated for testing the path information validity are hereafter referred to as empty packets—meaning that the packets are empty of data, comprising only the header information. However, this is not a prerequisite for implementing the invention, merely an advantageous embodiment. The packets used for testing the path information validity can contain any amount of data allowed by the protocol that is used.

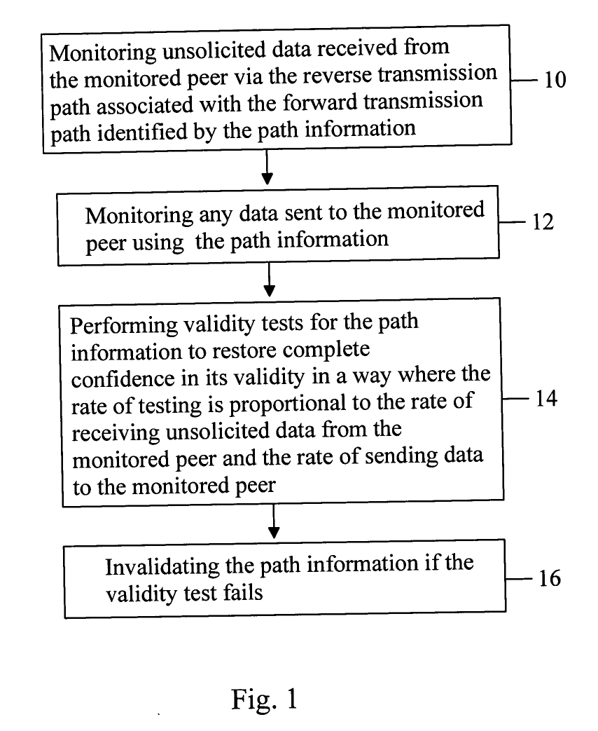

FIG. 1 discloses one embodiment of a method according to the invention. FIG. 1 discloses a method of determining validity of path information corresponding to a functional transmission path between a monitoring peer and a monitored peer in a data communication network. The monitoring peer monitors unsolicited data received from the monitored peer via the reverse transmission path associated with the forward transmission path identified by the path information and monitors any data sent to the monitored peer using the path information, steps 10 and 12.

In the invention a validity test may be performed in order to restore complete confidence in the validity of the path information. Validity tests are performed by the monitoring peer to restore complete confidence in its validity in a way where the rate of testing is proportional to the rate of receiving unsolicited data from the monitored peer and to the rate of sending data to the monitored peer, step 14. If the validity test fails, the path information is invalidated, step 16.

In one embodiment, a confidence factor is determined related to the validity of the path information corresponding to the transmission path between the monitoring peer and the monitored peer. The confidence factor is increased when receiving unsolicited data from the monitored peer. Furthermore, the confidence factor is decreased when using the path information to send data from the monitoring peer to the monitored peer. In other words, unsolicited data transmissions from the monitored peer increase confidence in the validity of the path information, but at the same time, it only proves that the peer exists and that the reverse data transmission path is functioning, without proving the forward data path is functioning. The use of the path information increases the need for confidence in the validity of the path information and thus, decreases confidence in its validity without testing to prove its validity. Therefore, a validity test for the path information to restore complete confidence in its validity is initiated when the value of the confidence factor reaches a predetermined low.

Yet in other words, the testing rate is dynamic in proportion to the use of the forward path and reversely proportional to the use of the reverse path. The first part means that testing is applied more as the forward path is used more, and the latter part means that receiving on the reverse path relaxes concern that the forward path is not working. The functions to determine change in the confidence factor is implementation dependent. In practice, the effect of sending data may have a stronger effect on decreasing confidence than receiving would on increasing it. That is to say that a highly used path should be tested often, even though receiving reverse data may relax the need somewhat—less used paths should be tested less often in any case.

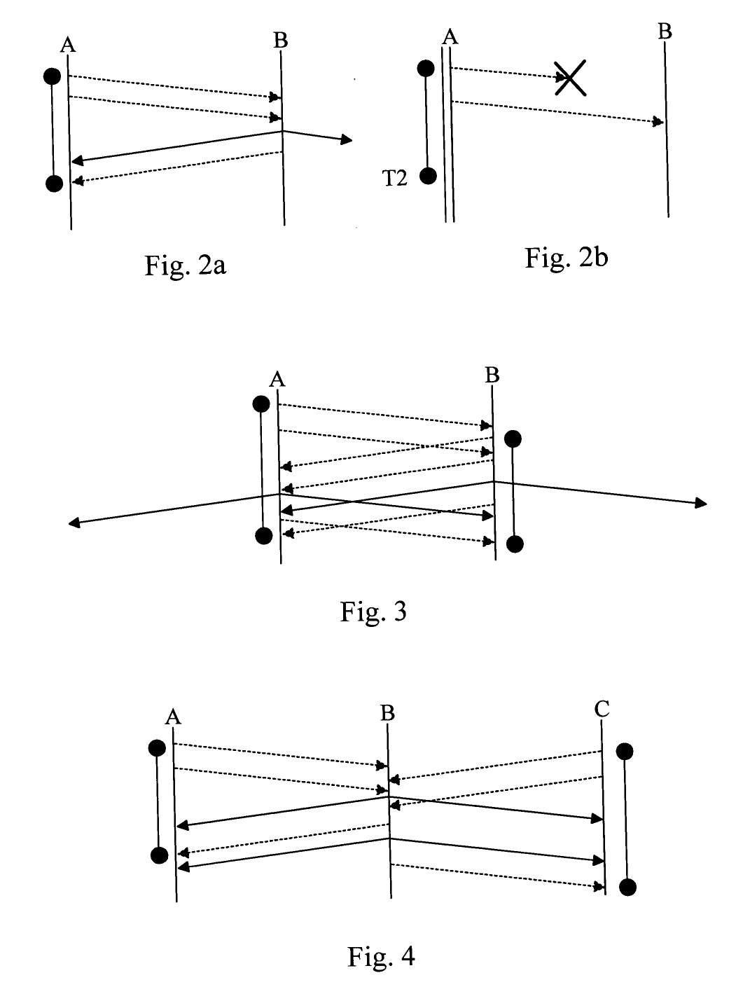

FIGS. 2a and 2b disclose one implementation embodiment of the invention. This embodiment uses unicast and broadcast packets with no user data to test the validity of path information corresponding to a transmission path between a monitoring peer A and a monitored peer B.

A timer T1 drives a base test rate applied even when there is no traffic on the forward path nor its associated reverse path. A timer T2 terminates a test in failure to receive confirmation.

In this embodiment, only one test is executed at a time. FIGS. 2a and 2b use the following sequence for testing validity.
request: [unicast(s,d), unicast(s,d)]
confirm: [broadcast(s,*), unicast(s,d)]
s=sender address; d=destination address; *=broadcast address.

Dashed lines represent empty unicast packets and solid lines empty broadcast packets. As can be seen from FIG. 2a the validity test succeeds since monitoring peer A receives a proper confirmation sequence. In FIG. 2b monitoring peer A does not receive a positive confirmation from monitored peer B since the first empty unicast packet is lost. Therefore, timer T2 terminates the validity test in failure to receive conformation from the monitored peer B.

FIG. 3 discloses an embodiment in which two peers A and B are testing each other in an overlapped manner. In this embodiment, both peers receive a positive confirmation to their validity testing. This embodiment uses similar packets as was disclosed in FIG. 2a.

FIG. 4 discloses an embodiment in which two peers A and c are testing B concurrently. Again, both A and C receive a positive confirmation to their validity testing of path information to B.

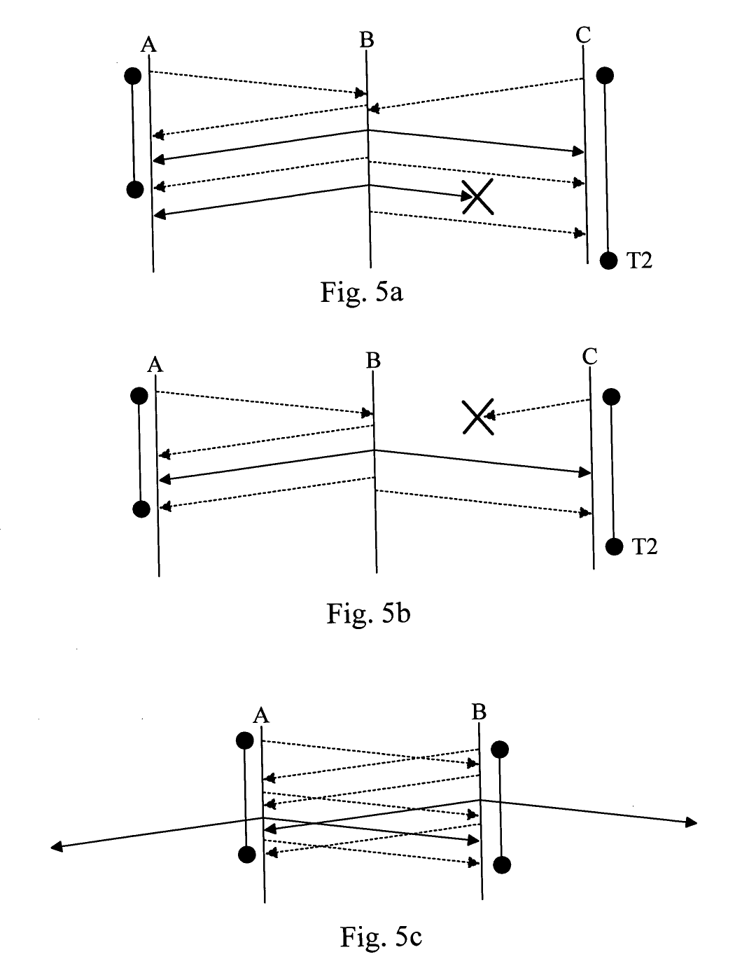

FIGS. 5a and 5b disclose another implementation embodiment of the invention. This embodiment uses unicast and broadcast packets to test the validity of path information.

In this embodiment, A abd C test B concurrently. FIGS. 5a and 5b use the following sequence for testing validity.
request: [unicast(s,d)]
confirm: [unicast(s,d), broadcast(s,*), unicast(s,d)]
s=sender address; d=destination address; *=broadcast address.

Again, dashed lines represent empty unicast packets and solid lines empty broadcast packets. Now, the broadcast in a confirmation sequence to another node (A) cannot be merged (at C) with any form of partial confirmation or test request from a monitored node (B) to form a false confirmation. In FIG. 5a, C might detect an explict break in the started confirmation, but this raises the question of how in any case C would know that a unicast is the start of a confirmation and not a test request. The answer can be seen from FIG. 5c by examining the sequence for the normal case of two nodes testing each other concurrently. The answer is that while testing a node, C can recognize the same node is testing it too when the second unicast arrives instead of a broadcast.

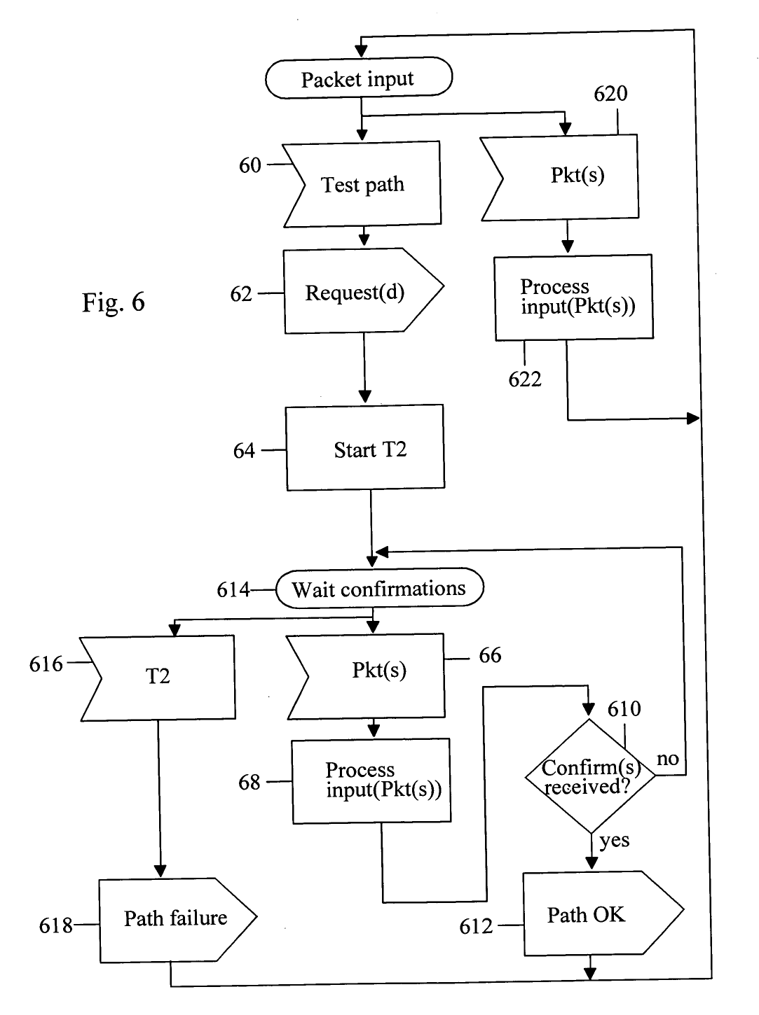

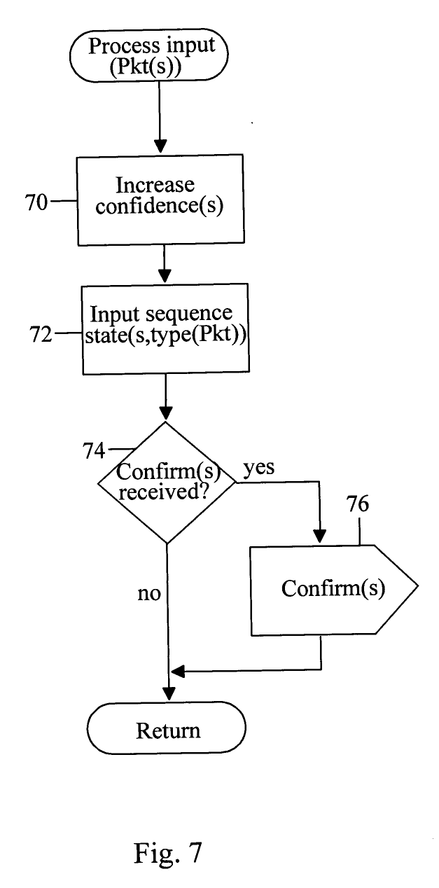

FIGS. 6 and 7 disclose one embodiment for packet input handling according to the invention. In FIG. 6 normal packet input processing divides input processing into two main states with regard to testing a path. In the first state, a queued test request can be dequeued and processing for the test is initialized before moving to the second state where the system waits for a confirmation sequence to be received. No new test request is processed in this state.

At steps 60 and 62 the monitoring peer internally determines to initiate a validity test of path information corresponding to a transmission path. At the same time a timer T2 is started, step 64. Timer T2 determines a time interval during which a positive confirmation to the validity test should be received from a monitored peer if the transmission path between the monitoring peer and the monitored peer is functional.

If packets are received (step 66) processing proceeds to step 68 in which received packets are processed. Input packet processing is described in FIG. 7. Unsolicited data transmissions from the monitored peer increases confidence in the validity of the path information (step 70) but it only proves that the peer exists and that the reverse data transmission path is functioning, without proving the forward data path is functioning. The monitoring peer determines whether the received packet(s) relate to a positive confirmation of a validity test, step 72. If it is determined that the packet(s) constitute a positive confirmation (steps 74 and 76), a confirmation output is output back to step 610 in FIG. 6. If the packet(s) did not relate to a confirmation of the validity test, processing returns back to step 610 of FIG. 6.

Relating to increasing confidence at step 70 in FIG. 7, generally the more data sent on a path should decrease confidence in sending data over the path without confirmation that it is received with the end result that testing occurs more frequently as the path is used more. At the same time, data received on the assosciated reverse path tends to increase confidence that the forward path is ok too, but does not prove it. Received data might be used to decrease the test rate and all the more if the received data can be shown to be related to the output on the path in question. For example, receiving simplex transmission gives the least confidence that the forward path also works.

Depending on the particular sequence syntax used for the protocol for validity testing and the implemented state update processing, it may be possible to detect a lost packet in the confirmation sequence and allow processing to declare failure before timer T2 expires.

If a positive confirmation was received from FIG. 7, the path information corresponding to the transmission path between the monitoring peer and the monitored peer is valid, step 612. The processing returns back to step 614 if the input packets did not relate to a confirmation of the validity test.

When the validity test was started timer T2 was started at the same time. Timer T2 determines a time interval during which a positive confirmation to the validity test should be received from the monitored peer if the transmission path between the monitoring peer and the monitored peer is functional. If a positive confirmation has not been received as timer T2 expires (step 616), a path failure signal is given, step 618.

Steps 620 and 622 represent a normal input packet handling, which is executed according to FIG. 7.

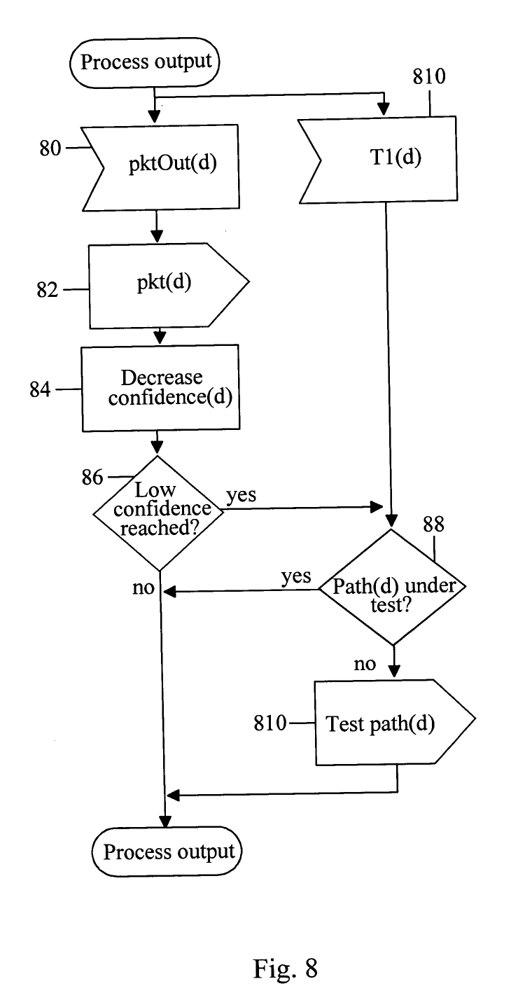

FIG. 8 discloses one embodiment for packet output processing. For each output packet (steps 80 and 82) the option is excercised to decrease confidence in the path information being used to output the packet. In this embodiment confidence is decreased with sending packets, step 84. The reasoning behind decreasing the confidence is that the use of the path information increases the need for confidence in the validity of the path information and thus, decreases confidence in its validity without testing to prove its validity. Therefore, the validity test for the path information to restore complete confidence in its validity is initiated the more frequently the smaller the value of the confidence factor is.

If a predetermined low confidence limit is reached and the path is not under a test (steps 86 and 88), the processing proceeds according to step 810 again to path testing (disclosed in FIGS. 6 and 7). A timer T1 drives a base test rate applied even when there is no traffic on the forward path nor its associated reverse path.

In one embodiment of the invention, empty unicast and broadcast packet sequences (e.g. the ones disclosed in FIGS. 2a and 5a) are used in the beginning in establishing the peer relationship between a monitoring and a monitored peer in a way that then would allow peer to continue with at least one empty packet protocol. Such a protocol could be the one in which both peers have agreed that the time-to-live (TTL) field of an IP packet is used to map confirmations to specific tests.

In the following another alternative embodiment for testing validity is disclosed. This embodiment refers e.g. to step 62 of FIG. 6.

A test protocol needs a request and response message, which maps a response to a particular request (i.e. both the monitoring and monitored peers as well as the particular test request must be derivable from the exchanged messages).

In order to get the needed extra information to map the messages and still use an empty Internet Protocol (IP) packet in a novel way, the invention takes the options variable part of the IP packet header to give the needed data. Alternatively, the time-to-live (TTL) field can be used, but that would limit the number of peers or nodes that can be monitored.

The following discloses one embodiment for a request message.

REQUEST: a unicast zero data length Internet Protocol packet header
1. id of monitored node; destination address field serves this purpose
2. id of the monitoring node; source address field serves this purpose
3. id of the particular test; encoded in an options variable:
   a. 1^{st}-2^{nd} octet=64, 4; 4 octets of option data, of class type debugging and measurement.
   b. 3^{rd}-4^{th} octet=test id. The further breakdown of this field is only understood by the monitoring node, for example:
      i. 12 bits=monitored node id; chosen by the monitoring node to uniquely identify the tested node among others that it also monitors.
      ii. 4 bits=test sequence number; a modular number which helps separate test requests near in time.

The following discloses one embodiment for a response message.

RESPONSE: a broadcast zero data length Internet Protocol packet header
1. id of monitored node; source address field serves this purpose
2. id of the monitoring node; derived from the test id (see REQUEST)
3. id of the particular test; derived from the test id (see REQUEST)

It should be noted that in a broadcast packet the destination address does not identify the monitoring node. Furthermore, the monitored node only needs to understand the that is being tested by the REQUEST and form the RESPONSE by simply changing the source and destination address fields appropriately—in particular it does not change the test id. Thus, the monitored nodes function is stateless.

In the implementation above the idea is to use empty packets to extend the IP to serve as a very light test protocol. It can be implemented by using the header options, or any other reasonable encoding of the IP packet header to give all the needed information. If not in single packets, then packet sequences also can signal the needed information.

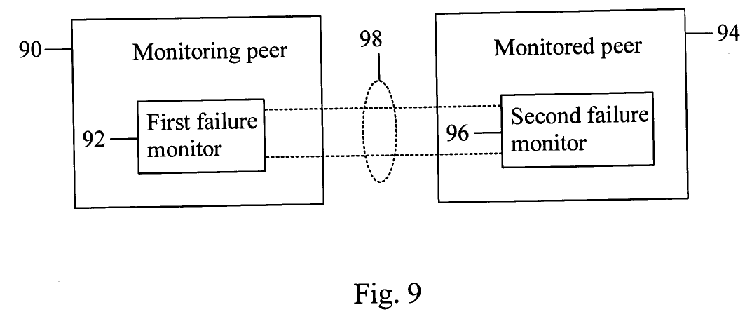

FIG. 9 illustrates one embodiment of a system according to the invention. The system comprises a monitoring peer 90 and a monitored peer 94 that are connected with each other via a transmission path 98 of a data communication network. Monitoring peer 90 comprises a first failure monitor 92 and monitored peer 94 comprises a second failure monitor 96. First failure monitor 92 is configured to monitor unsolicited data received from the monitored peer via the reverse transmission path associated with the forward transmission path identified by the path information, to monitor any data sent to the monitored peer using the path information, to perform validity tests for the path information to restore complete confidence in its validity in a way where the rate of testing is proportional to the rate of receiving unsolicited data from the monitored peer and the rate of sending data to the monitored peer and to invalidate the path information if the validity test fails.

In one embodiment first failure monitor 92 is further configured to determine a confidence factor representing the validity of the path information corresponding to the transmission path between the monitoring peer and the monitored peer, to increase the confidence factor when receiving unsolicited data from the monitored peer, to decrease the confidence factor when using the path information to send data from the monitoring peer to the monitored peer and initiate a validity test for the path information to restore complete confidence in its validity when the value of the confidence factor reaches a predetermined low.

In one embodiment of FIG. 9, first failure monitor 92 is further configured to determine a minimum rate of initiating the validity test and to initiate a validity test of the path information at least at intervals determined by the minimum rate.

In one embodiment first failure monitor 92 is further configured to send a request to the monitored peer and to invalidate the path information if a predetermined confirmation is not received in response to the request from the monitored peer. In one embodiment, the first failure monitor is configured to invalidate the path information if a predetermined confirmation in response to the request from the monitored peer is not received within a predetermined time interval. In one embodiment, at least one of the request and confirmation comprises at least one empty Internet Protocol packet. Yet in one embodiment, the request and confirmation are identified by at least one field of at least one Internet Protocol packet.

In one embodiment, first failure monitor 92 is further configured to send a predetermined sequence of empty Internet Protocol packets to monitored peer 94, second failure monitor 96 is configured to receive the predetermined sequence of empty Internet Protocol packets, second failure monitor 96 is configured to send, in response to the predetermined sequence of empty Internet Protocol packets, a predetermined response sequence of empty Internet Protocol packets to monitoring peer 90 and first failure monitor 92 is configured to invalidate the path information if a predetermined response sequence of empty Internet Protocol packets in response to the sent predetermined sequence of empty Internet Protocol packets is not received from monitored peer 94.

In one embodiment, first failure monitor 92 is configured to invalidate the path information if a predetermined response sequence of empty Internet Protocol packets in response to the sent predetermined sequence of empty Internet Protocol packets is not received from the monitored peer within a predetermined time interval. Yet in one embodiment the predetermined sequence of empty Internet Protocol packets sent to monitored peer 94 comprises at least one empty unicast Internet Protocol packet and the predetermined response sequence of empty Internet Protocol packets received from monitored peer 94 comprises at least one empty unicast Internet Protocol packet and at least one empty broadcast Internet Protocol packet.

In one embodiment, first failure monitor 92 and second failure monitor 96 are further configured to agree an identifier for the monitoring peer and the monitored peer by exchanging a predetermined sequence of empty Internet protocol packets between monitoring peer 90 and monitored peer 94, wherein at least one field of an empty Internet Protocol packet is used for identifying the identifier, and after agreeing the identifier, to identify the predetermined request and the predetermined confirmation by using at least one empty Internet Protocol packet, wherein at least one field of at least one empty Internet Protocol packet comprises the identifier.

It is obvious that monitoring peer 90 and monitored peer 94 comprise also other components and elements that are not shown in FIG. 9. For example, monitoring peer 90 and monitored peer 94 comprise a central processing unit (CPU) and at least one memory connected to the central processing unit. The memory may refer to a single memory or memory area or to a plurality memories or memory areas that may include e.g. random access memories (RAM), read-only memories (ROM) etc. Memory may also include other applications or software components that are not described in more detail and also may include the computer program (or portion thereof), which when executed on the central processing unit performs at least some of the steps of invention. The central processing unit may also include memory or a memory may be associated therewith which may include the computer program (or portion thereof) which when executed on the central processing unit performs at least some of the steps of the invention.

Is it obvious that monitored peer 94 may simultaneously act as a monitoring peer towards monitoring peer 90.

As a summary, the invention takes a new approach for validity testing of path information corresponding to a transmission path between a monitoring peer (A) and a monitored peer (B) and realizes that the whole question is a compromise of what facts are easy to obtain in contrast to answering whether the path information is correct or not. By re-emphasizing the practical close coupling of the two data paths of an interface, the invention relies on the event of failure in the forward path without failure also in the return data path to be unlikely. The invention allows other use of the transmission path from B to A to add confidence to the view that the transmission path from A to B is probably also working. That is, in contrast to prior art systems, A accepts any data from B as proof that B exists and the return data path works, as a confidence measure that the forward data path also works.

With this approach it is possible to use a slower rate of testing with extra data to prove the forward data path is functional while other data on the return path keeps confidence high that everything is functioning properly. Obviously confidence is based on the history of arriving data. What the rate is for no other data arriving, and how the rate is changed by the history of arriving other data are implementation issues. Prior art solutions to the problem solved by the invention have left the problem determining a rate for testing with extra data as an administrative issue to be solved taking into consideration of all the parameters to arrive at a constant value which must serve for the varying traffic patterns on the interface in question. The novel approach taken by the invention is to implement a system where the rate of self testing can vary according to the intuitive wisdom that faster failure detection is needed for higher user data rates (in order to loose less data before corrective measures sooner are applied).

An exemplary target of applicability of the invention is route failure detection needed by IP routing protocols, and in this case the path information has been called a “route path”.

A valid IP route corresponds to a functional forwarding path for a given destination address, and when this path fails the node's routing protocol needs to detect it to invalidate the route and determine a new route, if possible. The route tells a node where to forward IP packet data to move it towards its destination, either directly or indirectly. If the destination is not directly reachable, a route defines a directly reachable node's address, which should again forward the packet. Thus, as a minimum, a route defines a given interface and directly reachable address to use to reach a given destination address.

It is obvious to a person skilled in the art that with the advancement of technology, the basic idea of the invention may be implemented in various ways. The invention and its embodiments are thus not limited to the examples described above, instead they may vary within the scope of the claims.

We claim:

1. A method of determining validity of path information corresponding to a transmission path between a monitoring peer and a monitored peer in a data communication network, the method comprising:
monitoring unsolicited data received from a monitored peer via a reverse transmission path associated with a forward transmission path identified by path information;
monitoring any data sent to the monitored peer using the path information;
performing validity tests by a monitoring peer for the path information to restore complete confidence in its validity in a way where the rate of testing is proportional to the rate of receiving unsolicited data from the monitored peer and to the rate of sending data to the monitored peer; and
invalidating the path information if a validity test fails.

2. The method as claimed in claim 1, further comprising:
determining a confidence factor representing the validity of the path information corresponding to the transmission path between the monitoring peer and the monitored peer;
increasing the confidence factor when receiving unsolicited data from the monitored peer;
decreasing the confidence factor when using the path information to send data from the monitoring peer to the monitored peer; and
initiating the validity test for the path information to restore complete confidence in its validity when the value of the confidence factor reaches a predetermined low.

3. The method as claimed in claim 1, further comprising:
determining a minimum rate of initiating the validity test; and
initiating the validity test of the path information at least at intervals determined by the minimum rate.

4. The method as claimed in claim 1, further comprising:
sending a request from the monitoring peer to the monitored peer; and
invalidating the path information if the monitoring peer does not receive a predetermined confirmation in response to the request from the monitored peer.

5. The method as claimed in claim 4, further comprising:
invalidating the path information if the monitoring peer does not receive the predetermined confirmation in response to the request from the monitored peer within a predetermined time interval.

6. The method as claimed in claim 4, wherein at least one of the predetermined request and the predetermined confirmation comprises at least one internet protocol packet dedicated for testing path information validity.

7. The method as claimed in claim 5, wherein the predetermined request and the predetermined confirmation are identified by at least one field of at least one internet protocol packet.

8. The method as claimed in claim 4, further comprising:
sending a predetermined sequence of internet protocol packets dedicated for testing path information validity to the monitored peer from the monitoring peer; and
invalidating the path information if the monitoring peer does not receive a predetermined response sequence of internet protocol packets dedicated for testing path information validity in response to the predetermined sequence of dedicated internet protocol packets from the monitored peer.

9. The method as claimed in claim 8, further comprising:
invalidating the path information if the monitoring peer does not receive a predetermined response sequence of internet protocol packets dedicated for testing path information validity in response to the predetermined sequence of dedicated internet protocol packets from the monitored peer within a predetermined time interval.

10. The method as claimed in claim 8, further comprising:
including at least one unicast internet protocol packet in the predetermined sequence of internet protocol packets dedicated for testing path information validity from the monitoring peer to the monitored peer; and
including at least one unicast internet protocol packet and at least one broadcast internet protocol packet in the predetermined response sequence of internet protocol packets dedicated for testing path information validity from the monitored peer

11. The method as claimed in claim 4, further comprising:
agreeing to an identifier for the monitoring peer and the monitored peer by exchanging a predetermined sequence of internet protocol packets dedicated for testing path information validity between the monitoring peer and the monitored peer, wherein at least one field of an internet protocol packet is used for identifying the identifier, and
after agreeing the identifier, identifying the predetermined request and the predetermined confirmation by using at least one internet protocol packet dedicated for testing path information validity, wherein the at least one field of at least one dedicated internet protocol packet comprises the identifier.

12. The method as claimed in claim 6, wherein the at least one internet protocol packet dedicated for testing path information validity is effectively empty of data.

13. A computer program embodied on a computer readable medium for determining validity of path information corresponding to a transmission path between a monitoring peer and a monitored peer in a data communication network, the computer program controls the data-processing device to perform the following steps:
monitoring unsolicited data received from a monitored peer via the reverse transmission path associated with a forward transmission path identified by path information;
monitoring any data sent to the monitored peer using the path information;
performing validity tests by the monitoring peer for the path information to restore complete confidence in its validity in a way where the rate of testing is proportional to the rate of receiving unsolicited data from the monitored peer and to the rate of sending data to the monitored peer; and
invalidating the path information if a validity test fails.

14. The computer program according to claim 13, wherein the computer program further controls the data-processing device to perform the following steps:
determining a confidence factor representing a validity of the path information corresponding to a transmission path between the monitoring peer and the monitored peer;
increasing the confidence factor when receiving unsolicited data from the monitored peer;
decreasing the confidence factor when using the path information to send the data from the monitoring peer to the monitored peer; and
initiating a validity test for the path information to restore complete confidence in its validity when a value of the confidence factor reaches a predetermined low.

15. The computer program according to claim 13, wherein the computer program further controls the data-processing device to perform the following steps:
determining a minimum rate of initiating the validity test; and
initiating the validity test of the path information at least at intervals determined by the minimum rate.

16. The computer program according to claim 13, wherein the computer program controls the data-processing device to perform the following steps:
sending a request from the monitoring peer to the monitored peer; and
invalidating the path information if the monitoring peer does not receive a predetermined confirmation in response to the request from the monitored peer.

17. The computer program according to claim 16, wherein the computer program controls the data-processing device to perform the following steps:
invalidating the path information if the monitoring peer does not receive the predetermined confirmation in response to the request from the monitored peer within a predetermined time interval.

18. The computer program as claimed in claim 16, wherein at least one of the predetermined request and the predetermined confirmation comprises at least one internet protocol packet dedicated for testing path information validity.

19. The computer program according to claim 16, wherein the predetermined request and the predetermined confirmation are identified by at least one field of at least one internet protocol packet.

20. The computer program according to claim 16, wherein the computer program controls the data-processing device to perform the following steps:
sending a predetermined sequence of internet protocol packets dedicated for testing path information validity to the monitored peer; and
invalidating the path information if a predetermined response sequence of internet protocol packets dedicated for testing path information validity in response to the predetermined sequence of dedicated internet protocol packets is not received from the monitored peer.

21. The computer program according to claim 20, wherein the computer program controls the data-processing device to perform the following step:
invalidating the path information if the predetermined response sequence of internet protocol packets dedicated for testing path information validity in response to the predetermined sequence of dedicated internet protocol packets is not received from the monitored peer within a predetermined time interval.

22. The computer program according to claim 20, wherein the computer program controls the data-processing device to perform the following steps:
including at least one unicast internet protocol packet in the predetermined sequence of internet protocol packets dedicated for testing path information validity from the monitoring peer to the monitored peer; and including at least one unicast internet protocol packet and at least one broadcast internet protocol packet in the predetermined response sequence of internet protocol packets dedicated for testing path information validity from the monitored peer.

23. The computer program according to claim 16, wherein the computer program controls the data-processing device to perform the following steps:
agreeing to an identifier for the monitoring peer and the monitored peer by exchanging a predetermined sequence of internet protocol packets dedicated for testing path information validity between the monitoring peer and the monitored peer, wherein at least one field of an internet protocol packet is used for identifying the identifier, and
after agreeing the identifier, identifying the predetermined request and the predetermined confirmation by using at least one internet protocol packet dedicated for testing path information validity, wherein
the at least one field of at least one dedicated internet protocol packet comprises the identifier.

24. The computer program according to claim 13, wherein the computer program is stored on said computer readable medium.

25. A computer program embodied on a computer readable medium for sending data to a monitoring peer in a data communication network, the computer program controls the data-processing device to perform the following steps:
sending unsolicited data via a reverse transmission path to a monitoring peer;
receiving a validity test from the monitoring peer; and
sending a predetermined confirmation to the monitoring peer in response to the validity test.

26. The computer program according to claim 25, wherein the predetermined confirmation is identified by at least one field of at least one internet protocol packet.

27. The computer program as claimed in claim 25, wherein the computer program controls the data-processing device to perform the following step:
sending at least one internet protocol packet dedicated for testing path information validity as a confirmation to the monitoring peer in response to the validity test.

28. The computer program according to claim 25, wherein the computer program controls the data-processing device to perform the following steps:
receiving from the monitoring peer a predetermined sequence of internet protocol packets dedicated for testing path information validity; and
sending, in response to the predetermined sequence of dedicated internet protocol packets, a predetermined response sequence of internet protocol packets dedicated for testing path information validity to the monitoring peer.

29. The computer program according to claim 28, wherein:
the predetermined sequence of dedicated internet protocol packets from the monitoring peer comprises at least one unicast internet protocol packet; and
the predetermined response sequence of dedicated internet protocol packets to the monitoring peer comprises at least one unicast internet protocol packet and at least one broadcast internet protocol packet.

30. The computer program according to claim 25, wherein the computer program controls the data-processing device to perform the following steps:
agreeing to an identifier for the monitoring peer and the monitored peer by exchanging a predetermined sequence of internet protocol packets dedicated for testing path information validity between the monitoring peer and the monitored peer, wherein at least one field of an internet protocol packet is used for identifying the identifier, and
after agreeing to the identifier, identifying the predetermined request and the predetermined confirmation by using at least one internet protocol packet dedicated for testing path information validity, wherein the at least one field of at least one dedicated internet protocol packet comprises the identifier.

31. The computer program as claimed in claim 18, wherein the at least one internet protocol packet dedicated for testing path information validity is effectively empty of data.

32. The computer program according to claim 25, wherein said computer program is stored on said computer readable medium.

33. A monitoring peer for determining validity of path information corresponding to a transmission path between the monitoring peer and a monitored peer in a data communication network, the monitoring peer comprising:
a first failure monitor configured to
monitor unsolicited data received from a monitored peer via a reverse transmission path associated with a forward transmission path identified by path information,
monitor any data sent to the monitored peer using the path information,
perform validity tests for the path information to restore complete confidence in its validity in a way where the rate of testing is proportional to the rate of receiving unsolicited data from the monitored peer and to the rate of sending data to the monitored peer and,
invalidate the path information if a validity test fails.

34. The monitoring peer according to claim 33, wherein:
the first failure monitor is further configured to determine a confidence factor representing the validity of the path information corresponding to the transmission path between the monitoring peer and the monitored peer,
increase the confidence factor when receiving unsolicited data from the monitored peer,
decrease the confidence factor when using the path information to send data from the monitoring peer to the monitored peer and initiate the validity test for the path information to restore complete confidence in the validity when a value of the confidence factor reaches a predetermined low.

35. The monitoring peer according to claim 33, wherein:
the first failure monitor is further configured to determine a minimum rate of initiating the validity test and to initiate the validity test of the path information at least at intervals determined by the minimum rate.

36. The monitoring peer according to claim 33, wherein:
the first failure monitor is further configured to send a request to the monitored peer and to invalidate the path information if a predetermined confirmation is not received in response to the request from the monitored peer.

37. The monitoring peer according to claim 36, wherein the first failure monitor is configured to invalidate the path information if the predetermined confirmation in response to the request from the monitored peer is not received within a predetermined time interval.

38. The monitoring peer as claimed in claim 36, wherein at least one of the predetermined request and the predetermined confirmation comprises at least one internet protocol packet dedicated for testing path information validity.

39. The monitoring peer according to claim 36, wherein the predetermined request and the predetermined confirmation are identified by at least one field of at least one internet protocol packet.

40. The monitoring peer according to claim 33, wherein:
the first failure monitor is further is configured to send a predetermined sequence of internet protocol packets dedicated for testing path information validity to the monitored peer and to invalidate the path information if a predetermined response sequence of internet protocol packets dedicated for testing path information validity in response to the predetermined sequence of dedicated Internet Protocol packets is not received from the monitored peer.

41. The monitoring peer according to claim 40, wherein the first failure monitor is configured to invalidate the path information if the predetermined response sequence of internet protocol packets dedicated for testing path information validity in response to the predetermined sequence of internet protocol packets dedicated for testing path information validity is not received from the monitored peer within a predetermined time interval.

42. The monitoring peer according to claim 40, wherein the predetermined sequence of internet protocol packets dedicated for testing path information validity sent to the monitored peer comprises at least one unicast internet protocol packet and the predetermined response sequence of internet protocol packets dedicated for testing path information validity received from the monitored peer comprises at least one unicast internet protocol packet and at least one broadcast internet protocol packet.

43. The monitoring peer as claimed in claim 36, wherein:
the first failure monitor is further configured to agree to an identifier for the monitoring peer and the monitored peer by exchanging a predetermined sequence of internet protocol packets dedicated for testing path information validity between the monitoring peer and the monitored peer, wherein at least one field of an internet protocol packet is used for identifying the identifier, and
after agreeing to the identifier, to identify the predetermined request and the predetermined confirmation by using at least one internet protocol packet dedicated for testing path information validity, wherein at least one field of the at least one dedicated internet protocol packet comprises the identifier.

44. A monitored peer for sending data to a monitoring peer in a data communication network, the monitored peer comprising:
a failure monitor configured to
send unsolicited data via a reverse transmission path to a monitoring peer,
receive a validity test from the monitoring peer and
to send a predetermined confirmation to the monitoring peer in response to the validity test.

45. The monitored peer according to claim 44, wherein the predetermined confirmation is identified by at least one field of at least one internet protocol packet.

46. The monitoring peer as claimed in claim 38, wherein the at least one internet protocol packet dedicated for testing path information validity is effectively empty of data.

47. The monitored peer as claimed in claim 44, wherein the failure monitor is configured to send at least one internet protocol packet dedicated for testing path information validity as the predetermined confirmation to the monitoring peer in response to the validity test.

48. The monitored peer according to claim 44, wherein:
the failure monitor is configured to receive a predetermined sequence of internet protocol packets dedicated for testing path information validity from the monitoring peer and
to send, in response to the predetermined sequence of dedicatedinternet protocol packets, a predetermined response sequence of internet protocol packets dedicated for testing path information validity to the monitoring peer.

49. The monitored peer according to claim 48, wherein the predetermined sequence of dedicated internet protocol packets from the monitoring peer comprises at least one unicast internet protocol packet and the predetermined response sequence of dedicated internet protocol packets to the monitoring peer comprises at least one unicast internet protocol packet and at least one broadcast internet protocol packet.

50. The monitored peer according to claim 44, wherein the failure monitor is configured to agree to an identifier for the monitoring peer and the monitored peer by exchanging a predetermined sequence of internet protocol packets dedicated for testing path information validity between the monitoring peer and the monitored peer, wherein at least one field of an internet protocol packet is used for identifying the identifier, and after agreeing to the identifier, to identify the predetermined request and the predetermined confirmation by using at least one internet protocol packet dedicated for testing path information validity, wherein the at least one field of at least one dedicated internet protocol packet comprises the identifier.

51. The monitored peer as claimed in claim 47, wherein the at least one internet protocol packet dedicated for testing path information validity is effectively empty of data.

52. A system of determining validity of path information corresponding to a transmission path between a monitoring peer and a monitored peer in a data communication network, wherein the system comprises:
a monitoring peer comprising a first failure monitor, said first failure monitor being configured to monitor unsolicited data received from a monitored peer via a reverse transmission path associated with a forward transmission path identified by path information, to monitor any data sent to the monitored peer using the path information, to perform validity tests for the path information to restore complete confidence in its validity in a way where the rate of testing is proportional to the rate of receiving unsolicited data from the monitored peer and to the rate of sending data to the monitored peer and to invalidate the path information if the validity test fails; and
a monitored peer comprising a second failure monitor, said second failure monitor configured to send unsolicited data via the reverse transmission path to the monitoring peer, to receive the validity test from the monitoring peer and to send a predetermined confirmation to the monitoring peer in response to the validity test.

53. The system according to claim 52, wherein:
the first failure monitor is further configured to determine a confidence factor representing the validity of the path information corresponding to the transmission path between the monitoring peer and the monitored peer, to increase the confidence factor when receiving unsolicited data from the monitored peer, to decrease the confidence factor when using the path information to send the data from the monitoring peer to the monitored peer and initiate the validity test for the path information to restore complete confidence in the validity when a value of the confidence factor reaches a predetermined low.

54. The system according to claim 52, wherein:
the first failure monitor is further configured to determine a minimum rate of initiating the validity test and to initiate the validity test of the path information at least at intervals determined by the minimum rate.

55. The system according to claim 52, wherein:
the first failure monitor is further configured to send a request to the monitored peer and to invalidate the path information if the predetermined confirmation is not received in response to the request from the monitored peer.

56. The system according to claim 55, wherein the first failure monitor is configured to invalidate the path information if the predetermined confirmation in response to the request from the monitored peer is not received within a predetermined time interval.

57. The system as claimed in claim 55, wherein at least one of the predetermined request and the predetermined confirmation comprises at least one internet protocol packet dedicated for testing path information validity.

58. The system according to claim 55, wherein the predetermined request and the predetermined confirmation are identified by at least one field of at least one internet protocol packet.

59. The system according to claim 55, wherein:
the first failure monitor is further is configured to send a predetermined sequence of internet protocol packets dedicated for testing path information validity to the monitored peer;
the second failure monitor is configured to receive the predetermined sequence of dedicated internet protocol packets;
the second failure monitor is configured to send, in response to the predetermined sequence of dedicated internet protocol packets, a predetermined response sequence of internet protocol packets dedicated for testing path information validity to the monitoring peer; and
the first failure monitor is configured to invalidate the path information if a predetermined response sequence of dedicated internet protocol packets in response to the sent predetermined sequence of dedicated internet protocol packets is not received from the monitored peer.

60. The system according to claim 59, wherein the first failure monitor is configured to invalidate the path information if the predetermined response sequence of internet protocol packets dedicated for testing path information validity in response to the predetermined sequence of internet protocol packets dedicated for testing path information validity is not received from the monitored peer within a predetermined time interval.

61. The system according to claim 59, wherein the predetermined sequence of dedicated internet protocol packets sent to the monitored peer comprises at least one unicast internet protocol packet and the predetermined response sequence of dedicated internet protocol packets received from the monitored peer comprises at least one unicast internet protocol packet and at least one broadcast internet protocol packet.

62. The system as claimed in claim 55, wherein:
the first failure monitor and the second failure monitor are further configured to agree to an identifier for the monitoring peer and the monitored peer by exchanging a predetermined sequence of internet protocol packets dedicated for testing path information validity between the monitoring peer and the monitored peer, wherein at least one field of an internet protocol packet is used for identifying the identifier, and after agreeing to the identifier, to identify the predetermined request and the predetermined confirmation by using at least one internet protocol packet dedicated for testing path information validity, wherein the at least one field of at least one dedicated internet protocol packet comprises the identifier.

63. The system as claimed in claim 57, wherein the at least one internet protocol packet dedicated for testing path information validity is effectively empty of data.

64. A system of determining validity of path information corresponding to a transmission path in a data communication network, the system comprising:
first monitoring means for monitoring unsolicited data received from a monitored peer via a reverse transmission path associated with a forward transmission path identified by path information;
second monitoring means for monitoring any data sent to the monitored peer using the path information;
testing means for performing validity tests by a monitoring peer for the path information to restore complete confidence in its validity in a way where the rate of testing is proportional to the rate of receiving unsolicited data from the monitored peer and to the rate of sending the data to the monitored peer; and
invalidating means for invalidating the path information if a validity test fails.

65. A system of sending data to a monitoring peer in a data communication network, the system comprising:
first sending means for sending unsolicited data via a reverse transmission path to a monitoring peer;
receiving means for receiving a validity test from the monitoring peer; and
second sending means for sending a predetermined confirmation to the monitoring peer in response to the validity test.

66. A method of sending data to a monitoring peer in a data communication network, the method comprising:
sending unsolicited data via a reverse transmission path to a monitoring peer;
receiving a validity test from the monitoring peer; and
sending a predetermined confirmation to the monitoring peer in response to the validity test.
